(19) United States
(12) Patent Application Publication
(10) Pub. No.: US 2026/0100443 A1
(43) Pub. Date: Apr. 9, 2026

(54) BATTERY MODULE COOLING STRUCTURE

(71) Applicants: HYUNDAI MOTOR COMPANY, Seoul (KR); Kia Corporation, Seoul (KR)

(72) Inventors: Gungoo LEE, Hwaseong-si (KR); Jeongwon CHO, Hwaseong-si (KR)

(21) Appl. No.: 19/284,184

(22) Filed: Jul. 29, 2025

(30) Foreign Application Priority Data
Oct. 8, 2024 (KR) 10-2024-0136520

(51) Int. Cl. H01M 10/6557; H01M 10/613; H01M 10/6552; H01M 10/6567; H01M 50/204; H01M 50/242; H01M 50/289

(52) U.S. Cl. CPC H01M 10/6557; H01M 10/613; H01M 10/6552; H01M 10/6567; H01M 50/242; H01M 50/289; H01M 50/204

(57) ABSTRACT

A battery module cooling structure includes a plurality of battery cells arranged parallel to each other. The battery module cooling structure includes a cooling channel that is disposed between adjacent battery cells of the plurality of battery cells, the supports the plurality of battery cells, and that defines a cooling channel configured to cool the plurality of battery cells by carrying a cooling fluid therein. The cooling channel extends from a side surface of the plurality of battery cells in a vertical direction of the plurality of battery cells and then extends under the plurality of battery cells to sides of the adjacent battery cells in a horizontal direction.

### CROSS-REFERENCE TO RELATED APPLICATION

This application claims priority to and the benefit of Korean Patent Application No. 10-2024-0136520, filed with the Korean Intellectual Property Office, on Oct. 8, 2024, the entire contents of which are incorporated herein by reference.

### TECHNICAL FIELD

The present disclosure relates to a battery module cooling structure, and more particularly, to a battery module cooling structure having a heat pipe (cooling channel) disposed between battery cells, thus allowing a cooling fluid to flow within a battery module to cool the battery module.

### BACKGROUND

A battery pack for an eco-friendly vehicle may include a plurality of battery cells assembly to a battery module, and a plurality of battery modules may be assembly to a battery pack to be installed in the vehicle.

For example, a pouch cell-type battery module may broadly include the battery cell, a surface pressure pad, an end plate, a sensing board, or the like. The battery module may be provided by advanced battery cell cooling technology in accordance with high performance of the battery and its higher specification for rapid charging performance. Immersion cooling technology, which is a direct cooling method, may be considered to increase cooling performance of the battery, and components used in this immersion cooling method may include basic components of the battery module, a module housing, a cooling channel, and a coolant (or dielectric thermal fluid) for direct cooling.

In some cases, to cool an inner battery cell, a pipe may be disposed between the battery cells to implement the direct cooling using a coolant flow within the pipe. FIG. 1 shows a cooling structure in which a pipe 5 or 6 is disposed between a plurality of battery cells 1, and a gap filler 3 is disposed under the battery cells 1, and a cooling water channel 4 is disposed under the gap filler 3. As the pipe 5 or 6 has an ‘L’ shape, the PHP 5 or 6 may have a lower end part extending under the battery cell 1 disposed on one side thereof in the horizontal direction.

In some cases, as shown in FIG. 2, the longer the lower end part of the pipe 5 or 6, the better the cooling performance, and its length may extend up to twice a width of the battery cell 1. However, for the outermost cell, the length of the pipe 5 or 6 may only extend to the width of the battery cell 1, which increases the number of components.

In addition, as shown in FIG. 3, when adopting the existing ‘L’-shaped pipe 5, the cooling structure may have a curvature of a certain amount or more caused by bending of the end part of the pipe 5. Such a curvature may cause a gap of a certain amount or more between the battery cell 1 and the end part of the pipe 5, and an excessive application of the gap filler 3 may thus be required to fill this gap. In addition, different cooling conditions may occur between the adjacent battery cells 1 because the end part of pipe 5 is bent in only one direction.

### SUMMARY

The present disclosure describes a battery module cooling structure which can improve cooling performance efficiency and structural stability by configuring an end part of a pulsating heat pipe (PHP) in a ‘T’ shape, the PHP enabling a coolant to flow between battery cells of a battery module, thus allowing the coolant to flow evenly and smoothly between the battery cells.

According to one aspect of the subject matter described in this application, a battery module cooling structure for a plurality of battery cells arranged parallel to one another includes a cooling channel that is disposed between adjacent battery cells of the plurality of battery cells and supports the plurality of battery cells, where the cooling channel defines a cooling channel configured to carry a cooling fluid to thereby cool the plurality of battery cells. The cooling channel extends from a side surface of the plurality of battery cells in a vertical direction to a lower position below the plurality of battery cells and extends from the lower position toward sides of the adjacent battery cells in a horizontal direction.

Implementations according to this aspect can include one or more of the following features. For example, the cooling channel can include a plurality of vertical channels that extend from the side surface of the plurality of battery cells in the vertical direction, and a plurality of horizontal channels that are fluidly connected to the plurality of vertical channels, that are disposed below the plurality of battery cells, and that extend in the horizontal direction.

In some implementations, the cooling channel can include a vertical channel pattern portion that defines recesses corresponding to the plurality of vertical channels, and a vertical channel cover that is coupled to the vertical channel pattern portion to thereby define the plurality of vertical channels between the vertical channel pattern portion and the vertical channel cover. In some examples, the plurality of horizontal channels can include a first horizontal channel that is connected to a bottom of one of the plurality of vertical channels and extends to a first side along the horizontal direction, and a second horizontal channel that is connected to an end of the first horizontal channel and extend to a second side opposite to the first side in the horizontal direction. In some examples, each of the plurality of battery cells extends in a length direction orthogonal to the vertical direction and the horizontal direction, where the second horizontal channel extends in the length direction and is connected to another of the plurality of vertical channels.

In some implementations, the cooling channel can further include a connecting partition that is disposed and connects between the first horizontal channel and the second horizontal channel. The plurality of vertical channels can be configured to carry the cooling fluid in the vertical direction. In some examples, the first horizontal channel can be configured to carry the cooling fluid in the horizontal direction corresponding to a thickness direction of the plurality of battery cells, and the second horizontal channel can be configured to carry the cooling fluid in the thickness direction and in the length direction.

In some implementations, a portion of the second horizontal channel has a rounded shape and extends in the length direction. In some examples, the second horizontal channel is one of adjacent second horizontal flow paths that are disposed parallel to each other and spaced apart from each other in the length direction, where the adjacent second horizontal flow paths are configured to guide the cooling fluid in a same direction.

In some implementations, the first horizontal channel can be one of adjacent first horizontal flow paths that are disposed parallel to each other and spaced apart from each other in the length direction, the adjacent first horizontal flow paths being configured to guide the cooling fluid to in opposite directions.

In some implementations, the plurality of vertical channels can include adjacent vertical flow paths that are disposed parallel to each other and spaced apart from each other in the length direction, where the adjacent vertical flow paths are configured to guide the cooling fluid in opposite directions. In some examples, the first horizontal channel can be one of adjacent first horizontal flow paths that are disposed parallel to each other and spaced apart from each other in the length direction, where the adjacent first horizontal flow paths have different widths. In some examples, the adjacent vertical flow paths can have different widths.

In some implementations, the battery module cooling structure can further include a cooling water channel disposed below the plurality of battery cells and spaced apart from the plurality of battery cells in the vertical direction, where the cooling water channel defines a water channel configured to carry cooling water for exchanging heat with the plurality of battery cells. In some examples, the battery module cooling structure can further include a gap filler layer that is disposed in a space between a bottom of the plurality of battery cells and the cooling water channel, the gap filler layer covering and fixing a lower end part of the cooling channel.

In some implementations, the battery module cooling structure can further include a plurality of surface pressure pads disposed in a space between the plurality of battery cells where the cooling channel is not provided, where the plurality of surface pressure pads are configured to support side surfaces of the plurality of battery cells and to absorb swelling of the plurality of battery cells.

In some implementations, the cooling channel can be a pulsating heat pipe (PHP).

In some implementations, it can be possible to maximize the cooling performance efficiency by configuring the PHP enabling the coolant to flow between the battery cells of the battery module, thus allowing the coolant to be introduced, flow, and discharged through the optimal path between the battery cells.

In some implementations, it can be possible to uniformly cool all the battery cells by configuring the end part of the PHP in the ‘T’ shape to increase the length of the end part of the PHP up to twice the width of the battery cell.

In some implementations, it can be possible to contribute to securing the battery cell performance by reducing the number of PHP components to one, and preventing the radius of curvature caused by the bending of the end part to thus improve its assembly with the battery cell and ensure the structural stability.

### BRIEF DESCRIPTION OF THE DRAWINGS

FIG. 1 is a cross-sectional view showing an example of a cooling structure in related art.

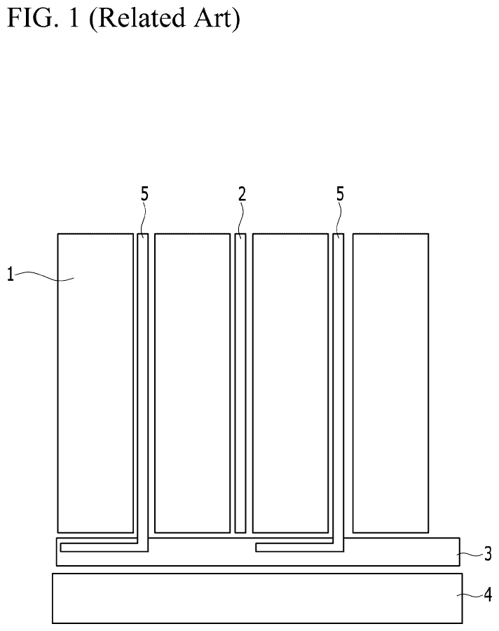

FIG. 2 is a cross-sectional view showing another example of a cooling structure in related art.

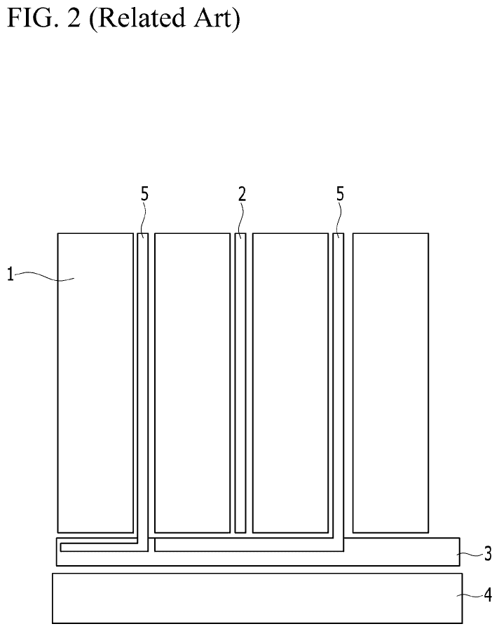

FIG. 3 is a cross-sectional view showing a state where curvature occurs due to bending of an end part of pipe in related art.

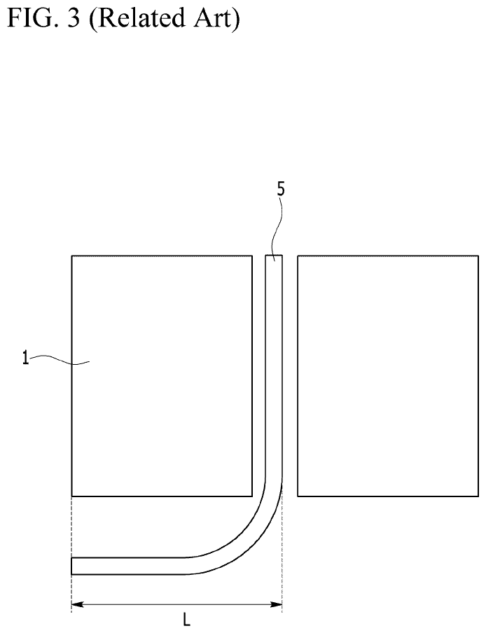

FIG. 4 is a cross-sectional view showing an example of a battery module cooling structure according to the present disclosure.

FIG. 5 is an exploded perspective view showing the battery module cooling structure.

FIG. 6 is a perspective view showing an example of a pulsating heat pipe (PHP) applied to the battery module cooling structure.

FIG. 7 is a cross-sectional view showing an example of a refrigerant flow in a cooling channel that is cut along line ‘A-A’ of FIG. 6.

FIG. 8 is a perspective view showing the refrigerant flow path in the cooling channel of the battery module cooling structure.

FIG. 9 is a view of the refrigerant flow enlarged from portion ‘B’ of FIG. 8.

### DETAILED DESCRIPTION

Hereinafter, implementations of the present disclosure are described in detail with reference to the accompanying drawings so that those skilled in the art to which the present disclosure pertains can easily practice the present disclosure. The present disclosure can be modified in various different forms, and is not limited to the implementations provided in the specification.

In addition, in several implementations, components having the same configuration will be representatively described using the same reference numerals in an implementation, and only components different from those of an implementation will be described in the other implementations.

Hereinafter, a battery module cooling structure is described in detail with reference to the accompanying drawings.

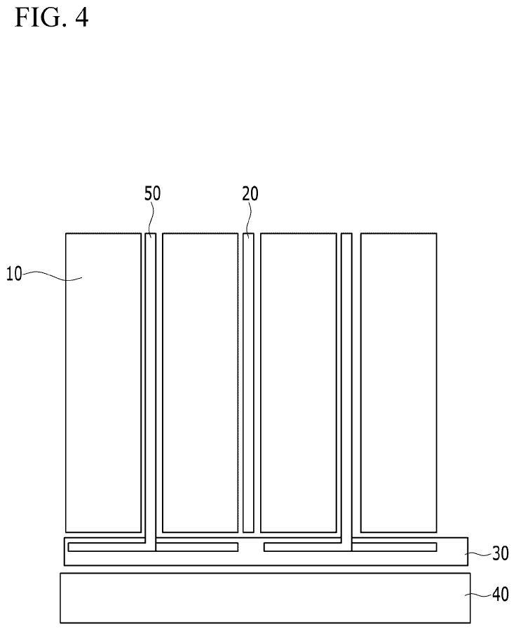

FIG. 4 is a cross-sectional view showing a battery module cooling structure.

Referring to FIG. 4, the battery module cooling structure can be configured to cool a battery module by assembling a plurality of battery cells 10 to be parallel to each other, and include a plurality of cooling channels 50 disposed between the plurality of battery cells 10.

In the present application, the cooling channel and the cooling channels therein may be used interchangeably. For example, the cooling channel 50 can be disposed between the plurality of battery cells 10 to serve to support the plurality of battery cells 10 and to cool the plurality of battery cells 10 by allowing a coolant to flow therein. The plurality of cooling channels 50 can be provided, extend in a vertical direction from a side surface of each of the plurality of battery cells 10 to the plurality of battery cells 10, and extend under the plurality of battery cells 10 to both sides of the plurality of adjacent battery cells 10 in a horizontal direction. That is, the cooling channel 50 can have a ‘T’ shape in a cross-section. In addition, the cooling channel 50 can be formed by a pulsating heat pipe (PHP).

In some implementations, a surface pressure pad 20 can be disposed between the plurality of battery cells 10 where no cooling channel 50 is disposed. The plurality of surface pressure pads 20 can be provided, and can serve to support the plurality of battery cells 10 and to absorb swelling of the plurality of battery cells 10.

In some implementations, in addition to the cooling structure formed by the cooling channel 50 disposed between the battery cells 10, the battery module cooling structure can also further include a cooling structure formed by a cooling water channel 40 disposed under the plurality of battery cells 10 while having a predetermined gap therefrom. The cooling water channel 40 can have cooling water flowing therein, can be disposed under the battery module, and can exchange heat with the battery module.

In addition, the battery module cooling structure can further include a gap filler layer 30 disposed in a space between the bottom of the plurality of battery cells 10 and the cooling water channel 40, and covering and fixing a lower end part of the cooling channel 50.

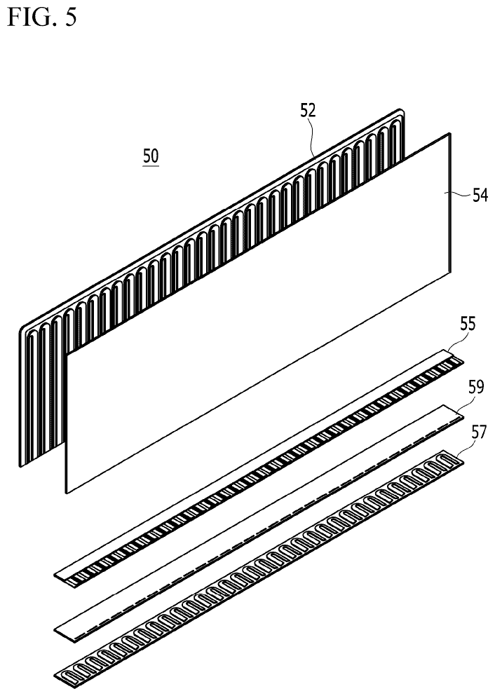

FIG. 5 is an exploded perspective view showing the battery module cooling structure.

Referring to FIG. 5, the cooling channel 50 can include a plurality of vertical channel portions 52 and 54 and a plurality of horizontal channels 55 and 57. Referring to FIGS. 4 and 5 together, the plurality of vertical channel portions 52 and 54 can extend from a side surface of the plurality of battery cells 10 in the vertical direction of the battery cell 10, i.e., an up-down direction.

In addition, the plurality of horizontal channels 55 and 57 can communicate with the plurality of vertical channel portions 52 and 54, respectively, and can extend under the battery cells 10 in the horizontal direction of the plurality of battery cells 10, i.e., its left-right direction. The vertical channel portions 52 and 54 can each be disposed between the adjacent battery cells 10, the horizontal channels 55 and 57 can each be connected to the lower end parts of the vertical channel portions 52 and 54, and extend under the adjacent battery cells 10 in the horizontal direction.

The vertical channel portions 52 and 54 can include the vertical channel pattern portion 52 including a flow path pattern through which a cooling fluid flows, and the vertical channel cover 54 forming a flow path by being coupled with the vertical channel pattern portion 52. The flow path pattern can have a continuous form by extending in the vertical direction of the vertical channel portions 52 or 54, i.e., the up-down direction, and being bent at the upper end part and lower end part of the vertical channel portions 52 or 54.

The plurality of horizontal channels 55 and 57 can include the first horizontal channel 55 and the second horizontal channel 57. The first horizontal channel 55 can be connected to the bottom of the vertical channel portions 52 or 54, and can extend in the horizontal direction of the battery cell 10, that is, its left-right direction. The second horizontal channel 57 can be connected to the bottom of the first horizontal channel 55, extend in the horizontal direction of the battery cell 10, i.e., its left-right direction in FIG. 4, extend in a length direction of the battery cell 10 (e.g., in a direction perpendicular to the sheet in FIG. 4), and be bent to be reconnected to the first horizontal channel 55 and the vertical channel portions 52 and 54.

The plurality of first horizontal channels 55 and the plurality of second horizontal channels 57 can be connected to each other using a plurality of connecting partitions 59, where the connecting partition 59 can partition the first horizontal channel 55 from the second horizontal channel 57.

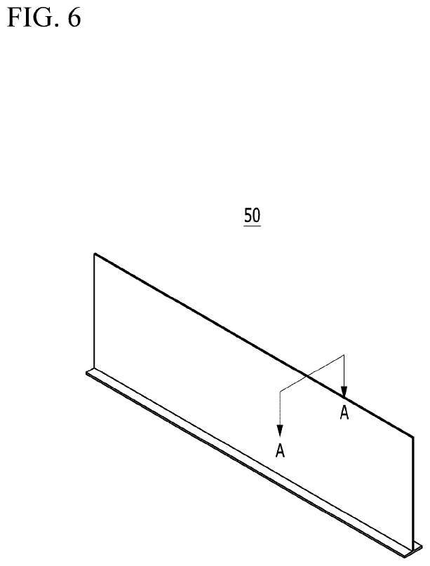

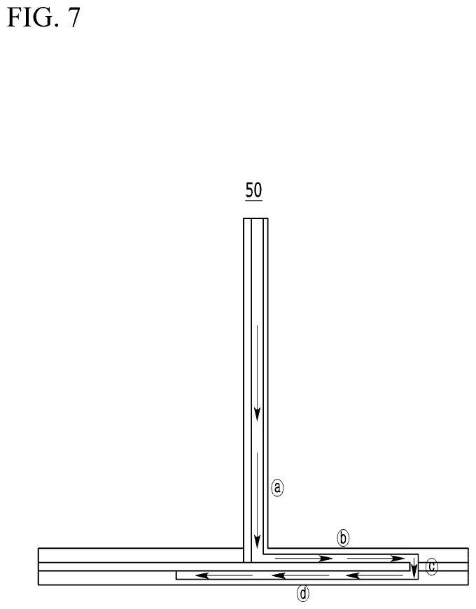

FIG. 6 is a perspective view showing the PHP applied to the battery module cooling structure, and FIG. 7 is a cross-sectional view showing a refrigerant flow in the cooling channel that is cut along line ‘A-A’ of FIG. 6.

Referring to FIGS. 6 and 7, the plurality of vertical channel portions 52 and 54 can form a vertical flow path ‘a’ by coupling the vertical channel pattern portion 52 with the vertical channel cover 54. The vertical flow path ‘a’ can provide a flow path of the cooling fluid in the vertical direction of the battery cell 10. In the vertical flow path ‘a’, the cooling fluid can flow from top to bottom.

The vertical flow path ‘a’ can have a continuous form by extending in the vertical direction of the vertical channel portions 52 or 54 and being bent at the upper end part and the lower end part of the vertical channel portions 52 or 54. Therefore, the cooling fluid can flow from the bottom to the top in the vertical flow path ‘a’ adjacent to the vertical flow path ‘a’ through which the cooling fluid flows from the top to the bottom.

The plurality of first horizontal channels 55 can form a first horizontal flow path ‘b’ through which the cooling fluid flows in a thickness direction of the battery cell 10, i.e., its left-right direction. In addition, the plurality of second horizontal channels 57 can form a second horizontal flow path ‘d’ through which the cooling fluid flows in the thickness direction of the battery cell 10, i.e., its left-right direction, and the length direction of the battery cell 10. The first horizontal flow path ‘b’ and the second horizontal flow path ‘d’ can be vertically partitioned from each other by the connecting member 59. The cooling fluid can pass through the first horizontal flow path ‘b’ and then pass through the second horizontal flow path ‘d’ through an intermediate flow path ‘c’ extending in the vertical direction.

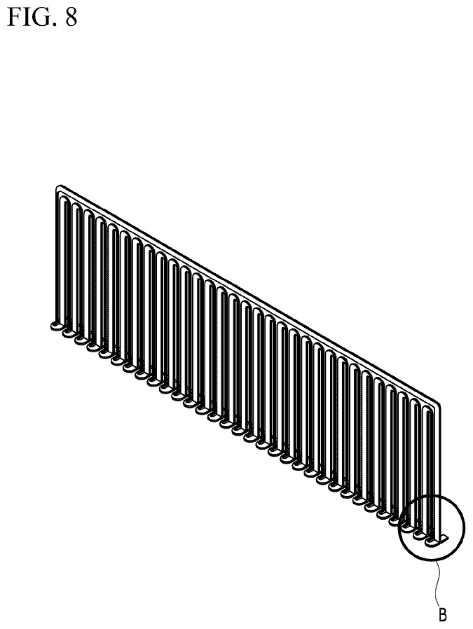

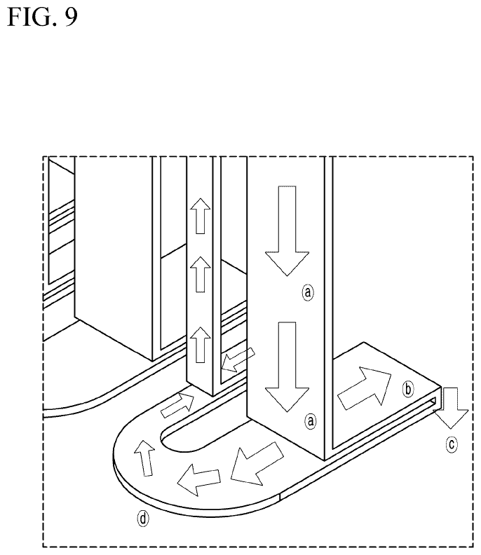

FIG. 8 is a perspective view separately showing only a refrigerant flow path in the cooling channel of the battery module cooling structure, and FIG. 9 is a view of the refrigerant flow enlarged from portion ‘B’ of FIG. 8.

Referring to FIGS. 8 and 9, the plurality of vertical flow path ‘a’ and the plurality of first and second horizontal flow paths ‘b’ and ‘d’ connected thereto can be provided in the length direction of the battery cell 10, and the flow path of the cooling fluid can be the same as a flow path shown in FIG. 9. That is, the cooling fluid can continuously flow in the following order: the vertical flow path ‘a’, the first horizontal flow path ‘b’, the intermediate flow path ‘c’, the second horizontal flow path ‘d’, the adjacent intermediate flow path ‘c’, the adjacent first horizontal flow path ‘c’, and the adjacent vertical flow path ‘a’. For this flow, the second horizontal flow path ‘d’ can include a flow path having a rounded shape in the length direction of the battery cell 10.

The adjacent second horizontal flow paths ‘d’ disposed to be parallel to each other in the length direction of the battery cell 10 can allow the cooling fluid to flow in the same direction. In addition, the plurality of adjacent first horizontal flow paths ‘b’ disposed to be parallel to each other in the length direction of the battery cell 10 can allow the cooling fluid to flow in opposite directions. In addition, the plurality of adjacent vertical flow paths ‘a’ disposed to be parallel to each other in the length direction of the battery cell 10 can allow the cooling fluid to flow in opposite directions.

In some implementations, the plurality of adjacent first horizontal flow paths ‘b’ disposed to be parallel to each other in the length direction of the battery cell 10 can have different widths. In addition, the plurality of adjacent vertical flow paths ‘a’ disposed to be parallel to each other in the length direction of the battery cell 10 can have different widths.

As set forth above, it is possible to maximize the cooling performance efficiency by configuring the PHP enabling the cooling fluid to flow between the battery cells of the battery module, thus allowing the cooling fluid to be introduced, flow, and discharged through the optimal path between the battery cells.

In addition, it is possible to uniformly cool all the battery cells by configuring the end part of the PHP in the ‘T’ shape to increase the length of the end part of the PHP up to twice the width of the battery cell.

In addition, it is possible to contribute to securing the battery cell performance by reducing the number of PHP components to one, and preventing the radius of curvature caused by the bending of the end part to thus improve its assembly with the battery cell and ensure the structural stability.

Although the implementations of the present disclosure have been described hereinabove, the scope of the present disclosure is not limited thereto, and all equivalent modifications easily modified by those skilled in the art to which the present disclosure pertains are intended to fall within the scope and spirit of the present disclosure.

What is claimed is:

1. A battery module cooling structure for a plurality of battery cells arranged parallel to one another, the battery module cooling structure comprising:
a cooling channel that is disposed between adjacent battery cells of the plurality of battery cells and supports the plurality of battery cells, the cooling channel defining a cooling channel configured to carry a cooling fluid to thereby cool the plurality of battery cells,
wherein the cooling channel extends from a side surface of the plurality of battery cells in a vertical direction to a lower position below the plurality of battery cells and extends from the lower position toward sides of the adjacent battery cells in a horizontal direction.

2. The battery module cooling structure of claim 1, wherein the cooling channel comprises:
a plurality of vertical channels that extend from the side surface of the plurality of battery cells in the vertical direction; and
a plurality of horizontal channels that are fluidly connected to the plurality of vertical channels, that are disposed below the plurality of battery cells, and that extend in the horizontal direction.

3. The battery module cooling structure of claim 2, wherein the cooling channel comprises:
a vertical channel pattern portion that defines recesses corresponding to the plurality of vertical channels; and
a vertical channel cover that is coupled to the vertical channel pattern portion to thereby define the plurality of vertical channels between the vertical channel pattern portion and the vertical channel cover.

4. The battery module cooling structure of claim 3, wherein the plurality of horizontal channels comprise:
a first horizontal channel that is connected to a bottom of one of the plurality of vertical channels and extends to a first side along the horizontal direction; and
a second horizontal channel that is connected to an end of the first horizontal channel and extend to a second side opposite to the first side in the horizontal direction,
wherein each of the plurality of battery cells extends in a length direction orthogonal to the vertical direction and the horizontal direction, and
wherein the second horizontal channel extends in the length direction and is connected to another of the plurality of vertical channels.

5. The battery module cooling structure of claim 4, wherein the cooling channel further comprises a connecting partition that is disposed and connects between the first horizontal channel and the second horizontal channel.

6. The battery module cooling structure of claim 5, wherein the plurality of vertical channels are configured to carry the cooling fluid in the vertical direction.

7. The battery module cooling structure of claim 6, wherein the first horizontal channel is configured to carry the cooling fluid in the horizontal direction corresponding to a thickness direction of the plurality of battery cells, and
wherein the second horizontal channel is configured to carry the cooling fluid in the thickness direction and in the length direction.

8. The battery module cooling structure of claim 7, wherein a portion of the second horizontal channel has a rounded shape and extends in the length direction.

9. The battery module cooling structure of claim 8, wherein the second horizontal channel is one of adjacent second horizontal flow paths that are disposed parallel to each other and spaced apart from each other in the length direction, the adjacent second horizontal flow paths being configured to guide the cooling fluid in a same direction.

10. The battery module cooling structure of claim 7, wherein the first horizontal channel is one of adjacent first horizontal flow paths that are disposed parallel to each other and spaced apart from each other in the length direction, the adjacent first horizontal flow paths being configured to guide the cooling fluid to in opposite directions.

11. The battery module cooling structure of claim 6, wherein the plurality of vertical channels include adjacent vertical flow paths that are disposed parallel to each other and spaced apart from each other in the length direction, the adjacent vertical flow paths being configured to guide the cooling fluid in opposite directions.

12. The battery module cooling structure of claim 9, wherein the first horizontal channel is one of adjacent first horizontal flow paths that are disposed parallel to each other and spaced apart from each other in the length direction, the adjacent first horizontal flow paths having different widths.

13. The battery module cooling structure of claim 11, wherein the adjacent vertical flow paths have different widths.

14. The battery module cooling structure of claim 1, further comprising:
a cooling water channel disposed below the plurality of battery cells and spaced apart from the plurality of battery cells in the vertical direction, the cooling water channel defining a water channel configured to carry cooling water for exchanging heat with the plurality of battery cells.

15. The battery module cooling structure of claim 14, further comprising:
a gap filler layer that is disposed in a space between a bottom of the plurality of battery cells and the cooling water channel, the gap filler layer covering and fixing a lower end part of the cooling channel.

16. The battery module cooling structure of claim 14, further comprising:
a plurality of surface pressure pads disposed in a space between the plurality of battery cells where the cooling channel is not provided, the plurality of surface pressure pads being configured to support side surfaces of the plurality of battery cells and to absorb swelling of the plurality of battery cells.

17. The battery module cooling structure of claim 1, wherein the cooling channel is a pulsating heat pipe (PHP).
